(19) United States
(12) Patent Application Publication
(10) Pub. No.: US 2013/0033721 A1
(43) Pub. Date: Feb. 7, 2013

(54) INFORMATION PROCESSING SYSTEM, INFORMATION PROCESSING APPARATUS, BUTTON PROCESSING METHOD, AND STORAGE MEDIUM

(71) Applicant: Daijiro Miyamoto, Kawasaki-shi (JP)

(72) Inventor: Daijiro Miyamoto, Kawasaki-shi (JP)

(73) Assignee: CANON KABUSHIKI KAISHA, Tokyo (JP)

(21) Appl. No.: 13/563,341

(22) Filed: Jul. 31, 2012

(30) Foreign Application Priority Data
Aug. 3, 2011 (JP) 2011-170022

(51) Int. Cl. G06K 15/02

(52) U.S. Cl. 358/1.14; 358/1.15

(57) ABSTRACT

An information processing system includes an image forming apparatus and an information processing apparatus. The information processing apparatus includes a registration unit configured to register a library, and an instruction unit configured to instruct the image forming apparatus to generate a button for accessing the registered library when the registration unit registers the library. The image forming apparatus includes a generation unit configured to generate the button for accessing the library from the image forming apparatus according to an instruction from the instruction unit, and a control unit configured to display the button generated by the generation unit on a display unit, and to access the library in response to selection of the displayed button.

### BACKGROUND OF THE INVENTION

1. Field of the Invention

The present invention relates to an information processing system in which an information processing apparatus and an image forming apparatus are capable of communicating with each other, an information processing apparatus, a button processing method, and a storage medium.

2. Description of the Related Art

Conventionally, some image forming apparatuses, including, for example, multifunction peripherals, have the function of storing a scanned document into an external storage device connected via a network, such as a folder in a file server or a document management system on the Internet. The image forming apparatuses having such a function can register, as a button, a shortcut for directly accessing a specific folder in the storage device in the network. Further, among such image forming apparatuses, there are image forming apparatuses configured to allow generation of the shortcut at the image forming apparatuses through transmission of information from an external information processing apparatus (for example, refer to Japanese Patent Application Laid-Open No. 2005-064817).

Further, there are image forming apparatuses that include an advanced box capable of storing an image file or a file format used in an office, and, therefore, can share a document or data stored in another multifunction peripheral by a multifunction peripheral cooperation function.

However, according to the conventional techniques, a user has to generate a shortcut at an image forming apparatus voluntarily by operating an information processing apparatus that the user is using, and it is inconvenient for generating a shortcut to be displayed on the image forming apparatus.

Further, under a cloud computing environment, when a user wants to print a certain document at an image forming apparatus by using an application for the Pull-Print function, the following processing is performed. For example, first, the user generates and edits a print target document on an application in an information processing apparatus. After that, at timing that the user wants to print it, the user acquires the registered document by operating an operation unit of the image forming apparatus and prints it by a printing unit.

During this procedure, the user, who is operating the image forming apparatus, has to go down from a root of a registered document server to a lower hierarchy or layer, clicking icons one by one, by operating the operation unit of the image forming apparatus to access the desired document in the cloud. At this time, if the user's target document is registered in a folder in a deeply located lower hierarchy or layer, the user has to carry out a complicated operation of going down through folders to print it. In this way, in execution of such information processing that an image forming apparatus and an information processing apparatus utilize a library, the conventional techniques fail to generate a unit (a button or a folder) allowing a user to refer to a processed document or the like from the image forming apparatus in a user-friendly manner. Therefore, according to the conventional techniques, cumbersome click operations and confirmation operations are required to refer to the document registered in the library from the image forming apparatus side.

Further, the conventional techniques fail to realize execution of the processing for generating the unit allowing a user to refer to a processed document or the like from an image forming apparatus, in association with the user's original target processing such as print processing or document registration processing. This leads to an inconvenience similarly for the user's operation for generating the unit allowing the user to refer to the processed document or the like from the image forming apparatus, whereby it is often difficult to improve usability.

### SUMMARY OF THE INVENTION

An aspect of the present invention is directed to an information processing system capable of automatically providing an image forming apparatus with a button allowing a user to directly access a library from the image forming apparatus when the user registers the library. Further, the present invention is directed to an information processing system capable of automatically providing an image forming apparatus with a button allowing a user to directly access a favorite folder generated in a library from the image forming apparatus when the user registers the library.

According to an aspect of the present invention, an information processing system includes an image forming apparatus and an information processing apparatus. The information processing apparatus includes a registration unit configured to register a library, and an instruction unit configured to instruct the image forming apparatus to generate a button for accessing the registered library when the registration unit registers the library. The image forming apparatus includes a generation unit configured to generate the button for accessing the library from the image forming apparatus according to an instruction from the instruction unit, and a control unit configured to display the button generated by the generation unit on a display unit, and to access the library in response to selection of the displayed button.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an example of the configuration of an information processing system including an information processing apparatus.

FIG. 2 illustrates an example of the hardware configuration of the information processing system.

FIG. 3 is a block diagram illustrating the software configuration of the information processing system.

FIG. 4 illustrates an example of a user interface (UI) screen displayed on the information processing apparatus.

FIG. 5 illustrates an example of printer list information stored in a printer management unit.

FIG. 6 illustrates an example of a UI screen displayed on the information processing apparatus.

FIG. 7 illustrates an example of a UI screen displayed on the information processing apparatus.

FIG. 8 illustrates a data format for storing a registration status of a library.

FIG. 9 illustrates a data format of setting information of a favorite button.

FIG. 10 illustrates an example of a UI screen displayed on an image forming apparatus.

FIG. 11 illustrates an example of a UI screen displayed on the image forming apparatus.

FIG. 12 is a flowchart illustrating a date processing method by the information processing apparatus.

FIG. 13 is a flowchart illustrating a date processing method by the information processing apparatus.

FIG. 14 is a flowchart illustrating a method for controlling the image forming apparatus.

FIG. 15 illustrates a data format of a function list acquired by the information processing apparatus.

FIG. 16 illustrates button information handled by the information processing apparatus.

FIG. 17 is a flowchart illustrating a date processing method by the information processing apparatus.

FIG. 18 is a flowchart illustrating a date processing method by the information processing apparatus.

FIG. 19 is a flowchart illustrating a date processing method by the information processing apparatus.

FIG. 20 illustrates a data format of library registration information handled by the information processing apparatus.

### DESCRIPTION OF THE EMBODIMENTS

Various exemplary embodiments, features, and aspects of the invention will be described in detail below with reference to the drawings.

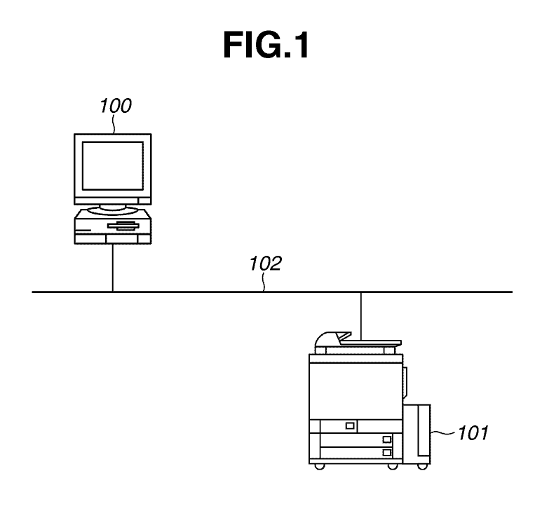

FIG. 1 illustrates an example of the configuration of an information processing system according to a first exemplary embodiment of the present invention, in which an image forming apparatus and an information processing apparatus are capable of communicating with each other. A system realizing the information processing system according to the present exemplary embodiment is provided in an information processing apparatus 100. Further, the information processing apparatus 100 is connected to a network 102 such as an Ethernet. The information processing apparatus 100 uses the network 102 to instruct an image forming apparatus 101 to, for example, print or facsimile document data via a printer driver or a facsimile driver capable of converting the document data into job data interpretable by the image forming apparatus 101. Referring to FIG. 1, the information processing apparatus 100 has hardware resources and software resources allowing the information processing apparatus 100 to execute various kinds of programs such as an application program, and the details thereof will be described below.

The image forming apparatus 101 has the functions of sharing and managing documents with clients, which functions are provided by a software installed in the image forming apparatus 101. The image forming apparatus 101 is connected to the network 102 via a network interface. Further, the image forming apparatus 101 analyzes job data transmitted from the information processing apparatus 100, which is a client, via the network 102 to convert the job data into image data, and prints the image data or transmits the image data by facsimile.

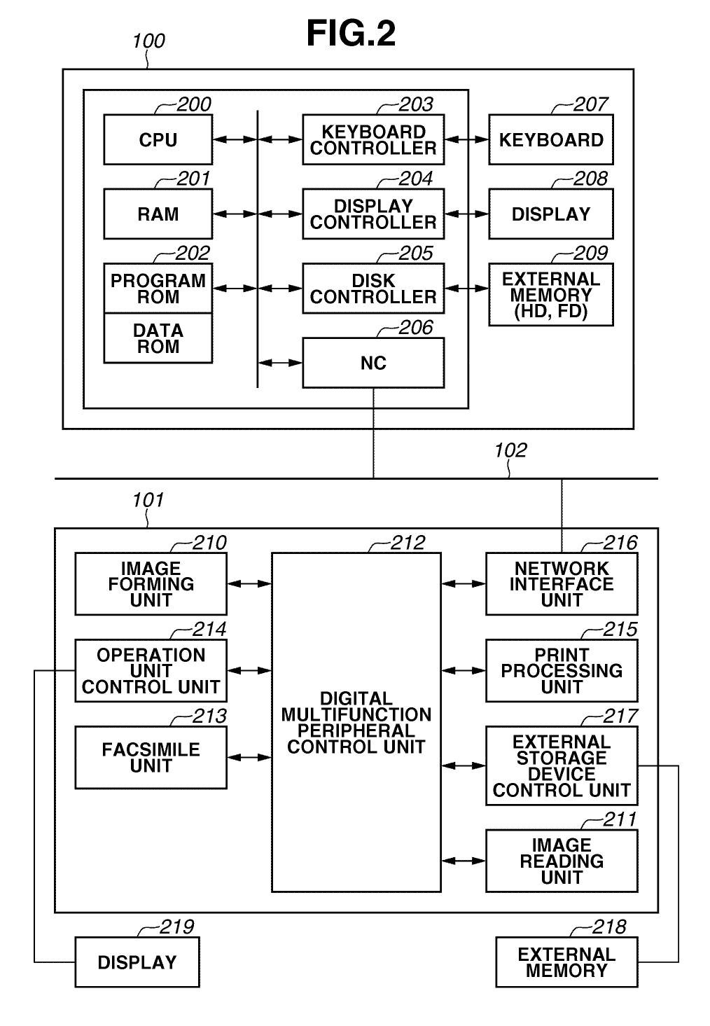

FIG. 2 illustrates an example of the hardware configuration of the information processing system according to the present exemplary embodiment. In the present example, the hardware of the information processing apparatus 100 can be constituted by hardware of a commonly-used information processing apparatus.

Referring to FIG. 2, a central processing unit (CPU) 200 executes a program such as an operating system (OS) or an application stored in a program read only memory (ROM) of a ROM 202 or loaded from a hard disk 209 to a random access memory (RAM) 201. The term “OS” is an acronym of “operating system”, which runs on a computer, and hereinafter, the operating system will be referred to as “OS”. The CPU 200 executes this program, thereby realizing the processing indicated by flowcharts that will be described below.

The RAM 201 functions as, for example, a main memory or a work area for the CPU 200. A keyboard controller 203 controls a key input from a keyboard 207 or a not-illustrated pointing device.

A display controller 204 controls a display of a display apparatus 208, which can be embodied by various kinds of display apparatuses. A disk controller 205 controls data access to the external memory 209 (including, for example, a hard disk (HD) and a flexible disk drive (FD)), which stores various kinds of data. The external memory 209 is used as a storage area for preparing a library. A network controller (NC) 206 is connected to the network 102, and controls communication with another apparatus connected to the network 102. In the present exemplary embodiment, the image forming apparatus 101 is implemented by a digital multifunction peripheral to which the present invention can be applied. However, the image forming apparatus 101 may be implemented by any other appropriate apparatus.

The image forming apparatus 101 includes an image forming unit 210, which carries out a series of image formation processes such as sheet handling, an image transfer, and image fixing to form an image on a recording medium such a recording sheet. The image forming unit 210 includes, for example, an ink-jet printing image forming unit or an electrophotographic image forming unit.

An image reading unit 211 includes an image sensor, and reads an image on a document to output digitized image data to a digital multifunction peripheral control unit 212. More specifically, the image reading unit 211 optically reads an image on a document to convert it into digital image information (image data), and outputs the digital image information to the image forming unit 210 to form an image. Further, the digital document image can be also transmitted via a line by being transferred to, for example, a facsimile unit 213 or a network interface unit 216.

The digital multifunction peripheral control unit 212 controls the respective operations of the image forming unit 210 and the image reading unit 211, and controls them, for example, in such a manner that document information read by the image reading unit 211 is copied by the image forming unit 210.

Further, the digital multifunction peripheral control unit 212 includes the network interface unit 216, a print processing unit 215, the facsimile unit 213, and an operation unit control unit 214, and also controls exchanges of information among these respective units.

The facsimile unit 213 can transmit and receive a facsimile document, i.e., for example, can transmit the digital image information read by the image reading unit 211, and decode a received facsimile signal to record it by the image forming unit 210.

Further, the operation unit control unit 214 generates a signal according to a user's operation with use of an operation panel at an operation unit, and controls the operation unit so as to display, for example, various kinds of data or a message on, for example, a display unit. The print processing unit 215 performs control, for example, to process print data input via, for example, the network interface unit 216, and output the print data to the image forming unit 210 to print the print data. Further, the network interface unit 216 controls data transmission/reception between the image forming apparatus 101 and another communication terminal via a communication line.

Further, an external storage device control unit 217 converts the image data read by the image reading unit 211 into a data format in which the image forming unit 210 can store into an external memory 218, and allows storage of the image data into the external memory 218. The external memory 218 is used as a storage area for preparing a library.

Further, the digital multifunction peripheral control unit 212 is configured to be able to read data stored in the external memory 218, and print the data via the image forming unit 210 or transmit the data to the outside via the network interface unit 216 and the network 102. The external memory 218 may be configured so as to function as an external memory of the image forming apparatus 101, or may be configured so as to function as a spool unit in the network 102 such as a server apparatus that provides the data spool function as a service under a cloud computing environment.

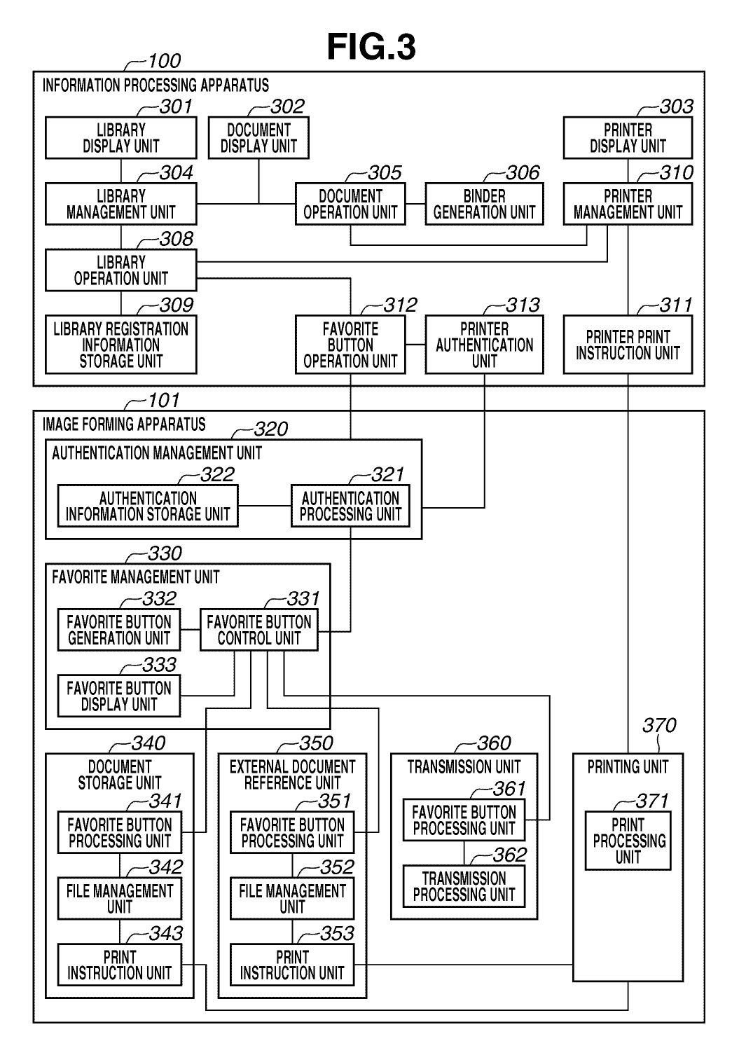

FIG. 3 is a block diagram illustrating the software configuration of the information processing system illustrated in FIG. 2. A document management system is stored in the external memory 209 of the information processing apparatus 100 of the present information processing system, and the OS develops the program into the RAM 201 in response to an activation request from a user, by which data processing is performed based on the document management system. Referring to FIG. 3, a user interface of the document management system includes a library display unit 301, a document display unit 302, and a printer display unit 303.

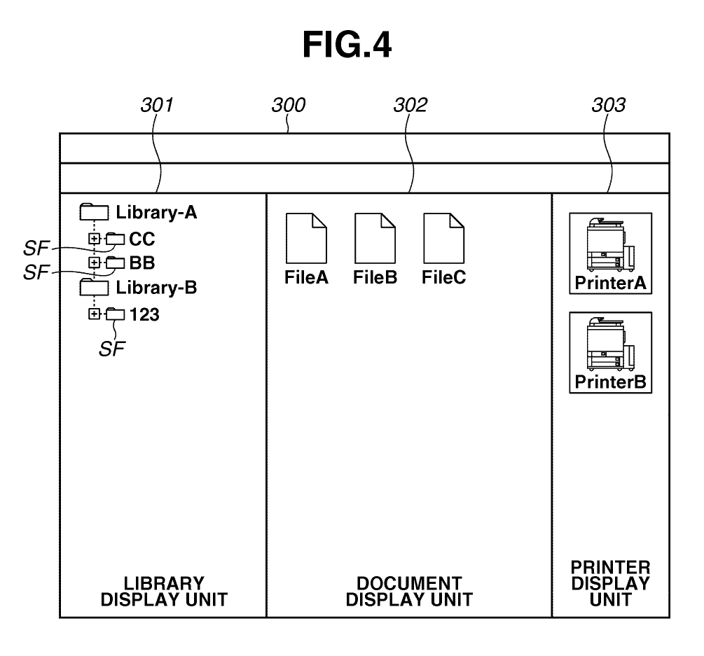

FIG. 4 illustrates an example of a user interface screen (UI screen) displayed on the display apparatus 208 of the information processing apparatus 100 illustrated in FIG. 2. In the present example, the UI screen is constituted by the library display unit 301, the document display unit 302, and the printer display unit 303. However, the UI screen may be configured to include any other display element.

A user operates an input apparatus to select one of libraries and one of subfolders SF in the selected library displayed on the library display unit 301 displayed on the display apparatus 208. Then, a library management unit 304 requests the document display unit 302 to display a list of files in the selected folder. Upon receiving the request, the document display unit 302 displays the requested list of files in a file list field illustrated in FIG. 4.

In the present exemplary embodiment, the library is, for example, a specific folder registered in a database or a file server. A user can carry out an operation provided by the document management system in the information processing apparatus 100 to a file stored in the library.

For example, the document management system provides the functions of, for example, moving/deleting/copying a file in the library, assigning an additional file attribute to a file in the library, and managing the version of a file in the library. In addition, the document management system provides, for example, the binder generation function of combining a plurality of documents into one document, assigning printing settings to the combined document, and storing the combined document as a binder document.

These functions are requested by a user via the document display unit 302 and are performed by a document operation unit 305. When the function of generating a binder document is requested by a user, the document operation unit 305 issues a generation instruction to a binder generation unit 306, and the binder generation unit 306 generates the binder document.

Further, a user drags and drops an icon displayed on the document display unit 302 to the printer display unit 303 on a document management screen 300 illustrated in FIG. 4, by which the corresponding file is printed by an image forming apparatus associated with the file icon. The list of image forming apparatuses displayed on the printer display unit 303 is managed by a printer management unit 310. The printer management unit 310 registers an image forming apparatus in response to an instruction to register the image forming apparatus from a user, or deletes the registration of an image forming apparatus.

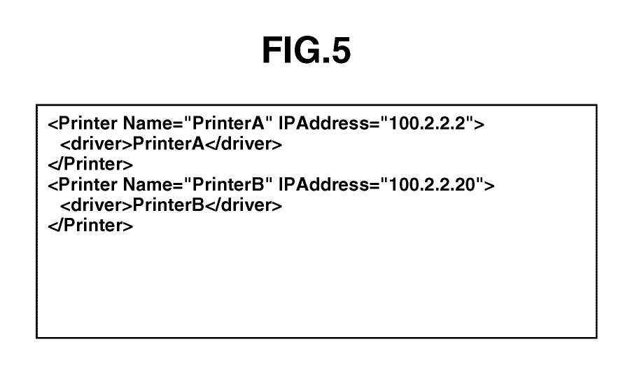

FIG. 5 illustrates an example of printer list information stored in the printer management unit 310 of the information processing apparatus 100 illustrated in FIG. 3. The present example corresponds to the printer list information in which printer apparatuses, Printer A and Printer B are registered as illustrated in FIG. 4. Referring to FIG. 5, for each of the printer icons displayed on the printer display unit 303 illustrated in FIG. 4, the printer management unit 310 holds the name of the icon, the printer driver to which a print request is issued at the time of printing, and the IP address of the printer.

When a user drags and drops the file icon representing a desired file to a printer icon on the UI screen illustrated in FIG. 4, the printer management unit 310 requests a printer print instruction unit 311 to print the dropped file. Upon receiving the print request, the printer print instruction unit 311 converts the data of the file to be printed to a command interpretable by the printer driver, and issues a print instruction to the printer driver corresponding to the image forming apparatus associated with the printer icon.

Upon receiving the print instruction, the printer driver converts the print data received from the printer print instruction unit 311 into a data format that is able to be processed by the image forming apparatus, and transmits the converted data to the image forming apparatus where the file is dropped. Then, upon receiving the print data, a printing unit 370 of the imaging forming apparatus interprets and prints the received data by a print processing unit 371. To manage a document by the information processing apparatus 100, first, a library should be registered. A library operation unit 308 is in charge of registration and deletion of a library.

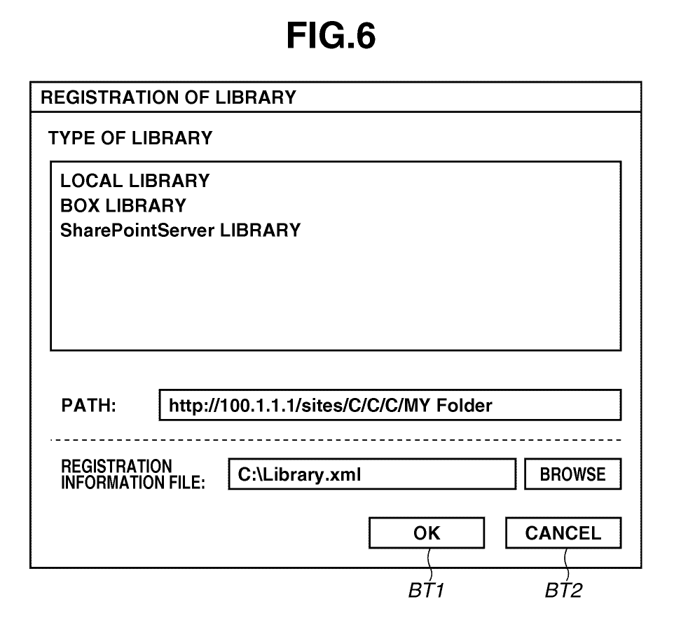

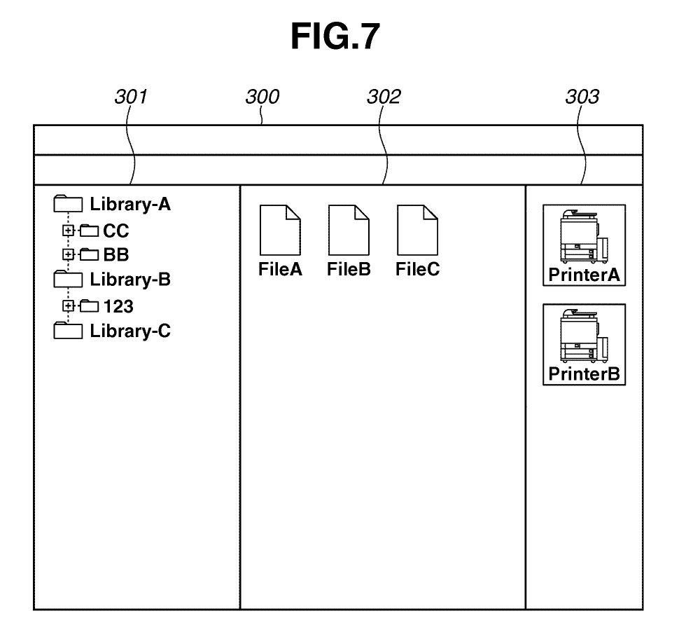

FIGS. 6 and 7 each illustrate an example of a user interface screen displayed on the information processing apparatus 100 illustrated in FIG. 2. The present example corresponds to a user interface screen for performing an operation of registering a library on the information processing apparatus 100. This screen is associated with the library operation unit 308, and is displayed on the display apparatus 208 by the library display unit 301.

This screen is displayed on the display apparatus 208 by the library display unit 301 when a user selects a menu item for registering a library from, for example, a menu. The user selects one library type that the user wants to register from a list of registrable library types displayed on the library registration screen, inputs reference information indicating a path (PATH) of an area that the user wants to use as a library, and pushes an “OK” button BT1. If the user wants to cancel the registration, the user pushes a “CANCEL” button BT2.

The example illustrated in FIG. 6 involves three types of libraries, namely, a local library, a box library, and a SharePointServer library. The local library is an area registered as a library in the hard disk (the external memory 209 illustrated in FIG. 2) of the information processing apparatus 100 on which the document management system is being carried out. The box library is a document storage area registered as a library in the hard disk (the external memory 218 illustrated in FIG. 2) of the image forming apparatus 101. A document is transmitted from or received by the box library with use of a protocol such as Server Message Block (SMB) or File Transfer Protocol (FTP). Further, the SharePointServer (“SharePoint” is a registered trademark) library is an area (prepared in a storage area) registered as a library in a library of SharePoint (registered trademark) Server of Microsoft Corporation. The present example is being described based on use of three library types by way of example, but a GoogleDocs library and a document storage area capable of communication in a specific format can be registered as a library.

A library may be registered not only by inputting the library manually, but also by loading a registration information file, which stores library information. The registration information file contains a library type and path information. For example, a system administrator distributes the registration information file to all users, for example, when the user wants them to use the same location.

The library operation unit 308 checks the library type, and tries to access the area indicated by the path by a method according to the library type. If the library operation unit 308 succeeds in the access, the library operation unit 308 adds the input information as library information to a library registration information storage unit 309. When the library operation unit 308 adds the library information in this way, the library management unit 304 reads the information, and requests the library display unit 301 to display it, thereby updating the display.

For example, registering a library in the name of “Library-C” results in an addition of information about “Library-C” to the library registration information. Then, the library management unit 304 updates the display, as a result of which an item indicating “Library-C” is added to the library display unit 301 as illustrated in FIG. 7.

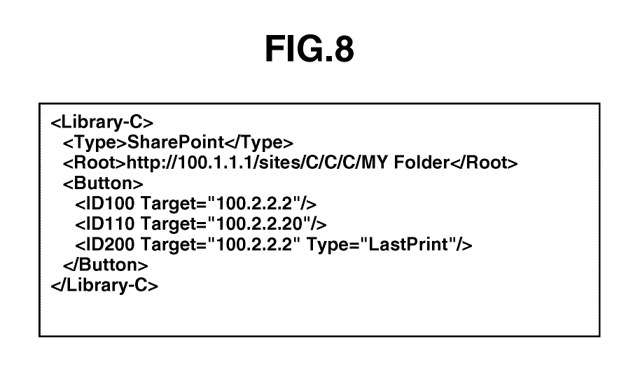

FIG. 8 illustrates an example of a data format for storing a registration status of a library in the information processing apparatus 100 according to the present exemplary embodiment. The data format illustrated in FIG. 8 stores, for each registered library, the name of the library, the path indicating the location of the library, the identification (ID) of a favorite button registered with the image forming apparatus 101 in association with the library, and the like.

The information processing apparatus 100 has the function of generating a favorite button at the image forming apparatus 101. The favorite button at the image forming apparatus 101 is a function of storing the status of a specific setting for a function of the image forming apparatus 101, and activating the stored function according to the stored setting in response to pushing a button displayed on the image forming apparatus 101. For example, storing the copy function with the settings of the color mode and the two-sided mode, or storing the file storage function with the setting of accessing a specific folder in an area where a file is to be stored if the image forming apparatus 101 has such a function as to allow a user to instantly call up that setting when the user wants to use it.

A favorite button operation unit 312 requests the image forming apparatus 101 to generate a favorite button at the image forming apparatus 101. First, the favorite button operation unit 312 issues a request for login to the image forming apparatus 101 to a printer authentication unit 313 to acquire permission to generate a button at the image forming apparatus 101. The printer authentication unit 313 requests a user to input a user ID and a password for login to the image forming apparatus 101, and receives the input information via the keyboard controller 203. Then, the printer authentication unit 313 requests an authentication management unit 320 of the image forming apparatus 101 to authenticate authentication information including the input user ID and password. After that, upon receiving the authentication request, the authentication management unit 320 transfers the received authentication information to an authentication processing unit 321 to compare the authentication information with information stored in an authentication information storage unit 322. At this time, if a combination of the user ID and the password is correct, the authentication processing unit 321 generates a login context based on the authentication information, and returns it to the information processing apparatus 100. After the authentication processing is completed in this way, the favorite button operation unit 312 of the information processing apparatus 100 generates setting information containing a description about settings of a favorite button that the user wants to generate. Further, the favorite button operation unit 312 transmits a favorite button generation request to the favorite management unit 330, together with the generated setting information and the login context received at the time of the authentication.

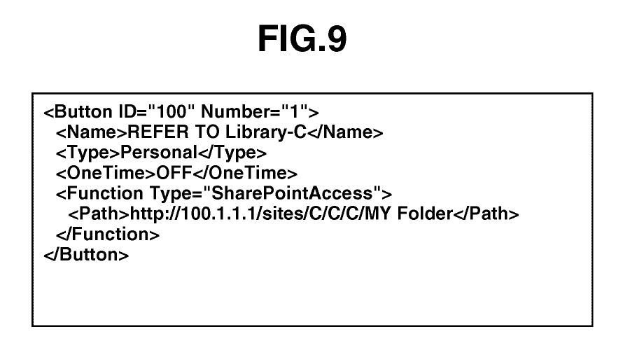

FIG. 9 illustrates an example of the data format of the setting information of a favorite button generated by the information processing apparatus 100 illustrated in FIG. 2. As illustrated in FIG. 9, the favorite button information includes an ID uniquely indicating the button, a name to be displayed on the user interface screen of the image forming apparatus 101, and a number indicating the location. Further, the favorite button information includes, for example, information indicating whether the button is set as a “My Button” (user-specific button), which can be used by only the login user, or set as a shared button, which can be used by all users, information indicating whether the button should be deleted after it is used once, and information about the function to be called up. The information about the function to be called up includes the name of the function and information required to use that function. The example illustrated in FIG. 9 indicates that the function of accessing a SharePointServer library from the image forming apparatus 101 is activated while the folder indicated by the path “http://100.1.1.1/sites/C/C/C/MY Folder” is opened.

Upon receiving the favorite button generation request, the favorite management unit 330 analyzes the received information by a favorite button control unit 331, and registers it as a favorite button by a favorite button generation unit 332. After that, the favorite button control unit 331 requests a favorite button display unit 333 to update the display. The favorite button display unit 333 updates the display of a display apparatus 219 of the image forming apparatus 101.

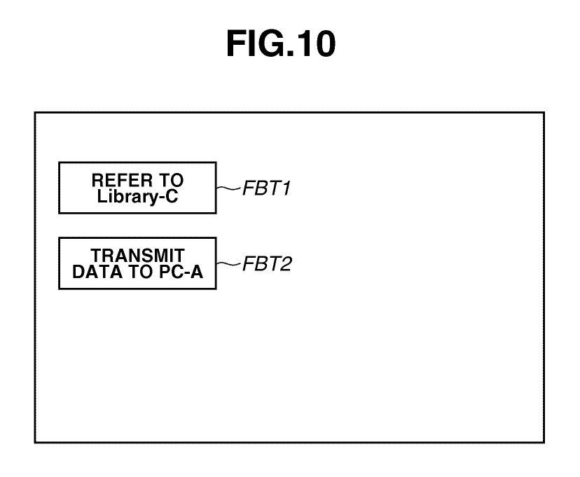

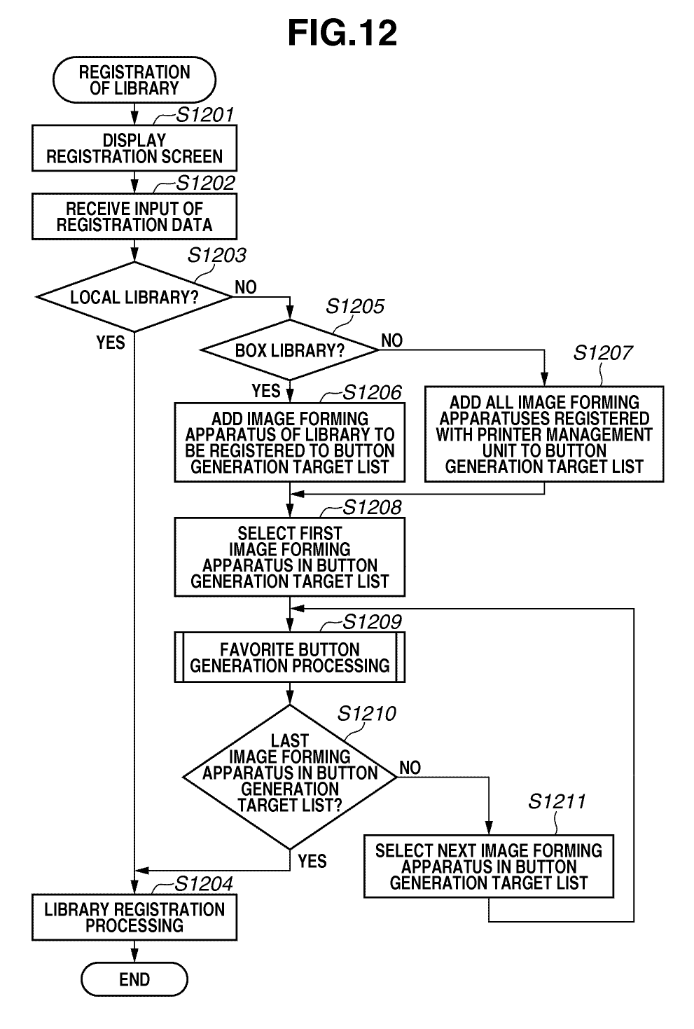

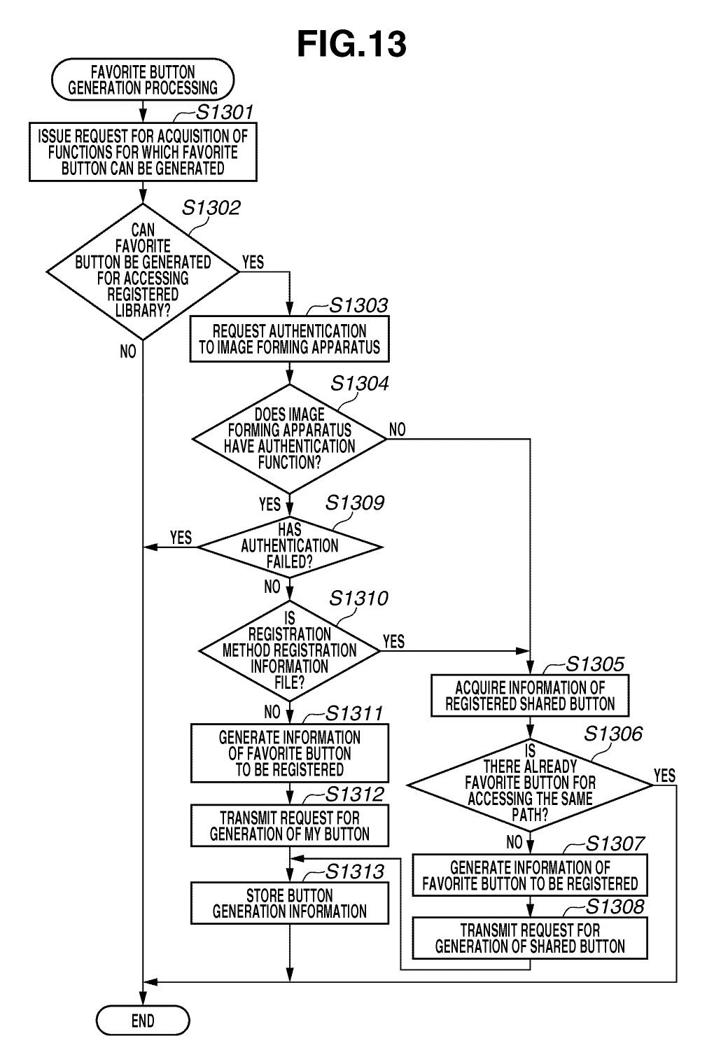

FIG. 10 illustrates an example of a user interface screen (UI screen) displayed on the display apparatus 219 of the image forming apparatus 101 illustrated in FIG. 2. The present example is an example of a user interface screen showing favorite buttons of the image forming apparatus 101. Both favorite buttons FBT1 and FBBT2 are buttons that the favorite management unit 330 of the image forming apparatus 101 generates to allow a user to access a library to be registered when the user registers the library on the information processing apparatus 100. The button generation processing will be described more concretely with reference to FIGS. 12 and 13. According to this processing, a button for accessing the above-described library is automatically generated at the image forming apparatus 101, and access to the library of the information processing apparatus 100 is realized in response to user's selection of this button.

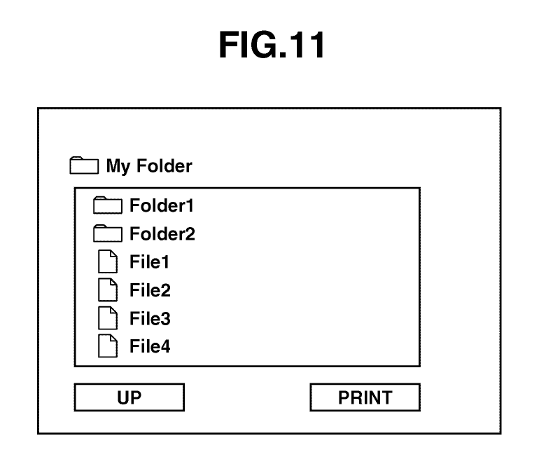

The favorite button registered with the image forming apparatus 101 calls up the registered function when a user pushes the button with its name displayed. After the function is called up, the screen of the called function is displayed on the display apparatus 219 in a state corresponding to the setting registered with the button. FIG. 11 illustrates an example of a user interface screen (UI screen) displayed on the display apparatus 219 of the image forming apparatus 101 illustrated in FIG. 2. The present example is an example of a user interface displayed when an external document reference unit 350 of the image forming apparatus 101 displays a specific folder.

FIG. 11 illustrates that user's pushing the favorite button FBT1 named “REFER TO Library-C” illustrated in FIG. 10 opens the folder indicated by the path “http://100.1.1.1/sites/C/C/C/MY Folder”, which is set to this button. Folders and files in the opened folder are shown in a list. The image forming apparatus 101 has the following functions.

A document storage unit 340 includes a favorite button processing unit 341, a file management unit 342, and a print instruction unit 343. The file management unit 342 manages scanned data and a file stored from, for example, the information processing apparatus 100 connected via the network 102 in a file storage area provided to the image forming apparatus 101. The print instruction unit 343 issues a print request to the printing unit 370, and prints a file managed by the file management unit 342.

The external document reference unit 350 includes a favorite button processing unit 351, a file management unit 352, and a print instruction unit 353. The file management unit 352 accesses a storage service in a file server or on the Internet, and acquires a file stored therein. The print instruction unit 353 issues a print request to the printing unit 370 to print the acquired file.

A transmission unit 360 includes a favorite button processing unit 361, and a transmission processing unit 362. The transmission processing unit 362 stores data of a scanned document while converting it into a set file format, and transmits the stored file by e-mail. Further, the transmission processing unit 362 transmits the stored file to, for example, a file server, according to a transmission protocol such as FTP, SMB, or Web-based Distributed Authoring and Versioning (WebDAV).

These functions have the favorite button processing units 341, 351, and 361 to operate as favorite buttons. When user's pushing a favorite button is detected by the favorite button display unit 333, the favorite button control unit 331 receives that request, and transfers the information of the function to be called up to any of the favorite button processing units 341, 351, and 361 of the respective functions. Then, upon receiving this information, the favorite button processing unit 341, 351, or 361 analyzes the received information, and calls up the function associated with the favorite button processing unit 341, 351, or 361.

FIG. 12 is a flowchart illustrating a data processing method by the information processing apparatus 100 according to the present exemplary embodiment. The present example is an example of the button generation processing performed by the information processing apparatus 100 when a library is registered. The CPU 200 of the information processing apparatus 100 illustrated in FIG. 2 loads the control program and the above-described modules onto the RAM 201 to execute them, by which the respective steps are realized. Hereinafter, the document processing method will be described as if the modules illustrated in FIG. 3 perform control actually.

First, when the information processing apparatus 100 receives an instruction from a user who operates, for example, the keyboard 207, library registration processing is called up. In step S1201, the library operation unit 308 of the information processing apparatus 100 displays a screen for library registration as illustrated in FIG. 6 on the display apparatus 208. In step S1202, the library operation unit 308 receives inputs of a library type that a user wants to register, a folder path, and a registration information file from the user.

Subsequently, in step S1203, the library operation unit 308 determines the library type to be registered based on the information input by the user on the UI screen illustrated in FIG. 6. If the library operation unit 308 determines in step S1203 that the library type is a local library, which is the external memory 209 in the information processing apparatus 100 (YES in step S1203), the processing proceeds to step S1204. In step S1204, the library operation unit 308 registers a library with the external memory 209 in the information processing apparatus 100. Then, the present processing ends.

At this time, during the library registration processing, the library operation unit 308 generates the information as illustrated in FIG. 8, and the library operation unit 308 stores the generated information into the external memory 209, thereby registering the library. On the other hand, if the library operation unit 308 determines in step S1203 that the library type to be registered is not a local library (NO in step S1203), subsequently, in step S1205, the library operation unit 308 determines whether the library type to be registered is a box library, which indicates a file storage area within the image forming apparatus 101. The box library is generated in the external memory 218 of the image forming apparatus 101 illustrated in FIG. 2.

If the library operation unit 308 determines that the library type to be registered is a box library (YES in step S1205), then in step S1206, the library operation unit 308 extracts an Internet Protocol (IP) address from the path information of that box library, and adds the extracted IP address to a button generation target list. If the library operation unit 308 determines in step S1205 that the library type to be registered is not a box library (NO in step S1205), the processing proceeds to step S1207. Then, in step S1207, the library operation unit 308 determines that the library type to be registered is a SharePointServer library, and adds all of image forming apparatuses managed by the printer management unit 310 to the button generation target list.

Subsequently, in step S1208, the library operation unit 308 selects the first image forming apparatus in the generated button generation target list. Then, in step S1209, the library operation unit 308 performs favorite button generation processing on the selected image forming apparatus. The details of the favorite button generation processing will be described with reference to FIG. 13.

At this time, if the library operation unit 308 registers the library based on the registration information file, the library operation unit 308 notifies the favorite button operation unit 312 of this fact. Then, after completion of the favorite button generation processing, in step S1210, the library operation unit 308 determines whether the currently selected image forming apparatus in the button generation target list is the last image forming apparatus. If the library operation unit 308 determines in step S1210 that the currently selected image forming apparatus is the last image forming apparatus (YES in step S1210), then in step S1204, the library operation unit 308 performs the library registration processing. At this time, the library operation unit 308 adds the information of the button generated by the favorite button generation processing to the information of the registered library.

On the other hand, if the library operation unit 308 determines in step S1210 that the currently selected image forming apparatus is not the last image forming apparatus (NO in step S1210), then in step S1211, the library operation unit 308 selects the image forming apparatus next to the currently selected image forming apparatus from the button generation target list. Subsequently, in step S1209, the library operation unit 308 performs the favorite button generation processing on all of image forming apparatuses registered with the list.

FIG. 13 is a flowchart illustrating a data processing method by the information processing apparatus 100 according to the present exemplary embodiment. The present example is an example of the favorite button generation processing at the time of library registration in step S1209 illustrated in FIG. 12. The favorite button operation unit 312 performs this processing by receiving the information of the image forming apparatus 101, at which a favorite button is generated, the library information, and the information of the library registration method from the library operation unit 308 performing the processing illustrated in FIG. 12. The CPU 200 of the information processing apparatus 100 illustrated in FIG. 2 loads the control program and the above-described modules onto the RAM 201 to execute them, by which the respective steps are realized. Hereinafter, the document processing method will be described as if the modules illustrated in FIG. 3 perform control actually.

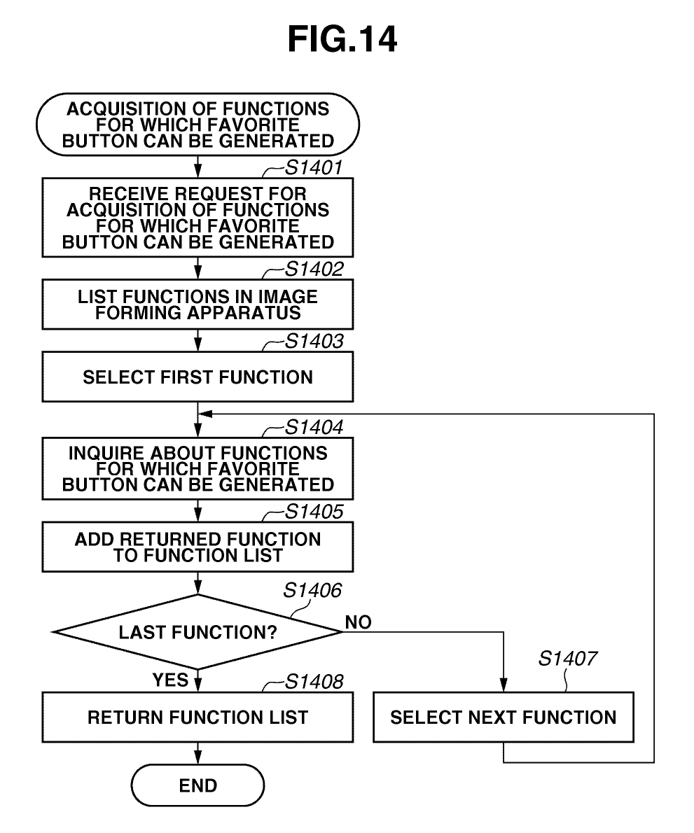

First, in step S1301, the favorite button operation unit 312 of the information processing apparatus 100 requests acquisition of functions for which a favorite button can be generated to the target image forming apparatus 101. The image forming apparatus 101 and the information processing apparatus 100 exchange processing by using a web service according to a protocol such as Simple Object Access Protocol (SOAP) via the network 102. However, the communication unit does not have to be a web service. The image forming apparatus 101 and the information processing apparatus 100 may communicate with each other by using, for example, Representational State Transfer (Rest) or a special protocol. Upon receiving an inquiry about functions for which a favorite button can be generated from the information processing apparatus 100, the favorite management unit 330 of the image forming apparatus 101 performs the processing illustrated in FIG. 14.

FIG. 14 is a flowchart illustrating a method for controlling the image forming apparatus 101 according to the present exemplary embodiment. The present example is an example of the processing performed by the favorite management unit 330 of the image forming apparatus 101 to acquire a list of functions for which a favorite button can be generated after receiving an inquiry about functions for which a favorite button can be generated from the information processing apparatus 100. Further, upon receiving the request, the favorite button control unit 331 of the favorite management unit 330 in the image forming apparatus 101 performs this processing. The CPU of the digital multifunction peripheral control unit 212 loads the modules illustrated in FIG. 3 onto the RAM to execute them, by which the respective steps are realized. Hereinafter, the document processing method will be described as if the modules illustrated in FIG. 3 perform control actually.

First, in step S1401, the favorite button control unit 331 receives a request for acquisition of functions for which a favorite button can be generated from the information processing apparatus 100. After the favorite button control unit 331 receives this request from the information processing apparatus 100, in step S1402, the favorite button control unit 331 lists the functions of the image forming apparatus 101. Then, in step S1403, the favorite button control unit 331 selects the first function among the acquired functions.

Then, in step S1404, the favorite button control unit 331 issues an inquiry about a function for which a favorite button can be generated to the favorite button processing unit 341, 351, or 361 of the selected function. Upon receiving this inquiry, the favorite button processing unit 341, 351, or 361 of the selected function of the image forming apparatus 101 returns the information of the function thereof.

For example, if the favorite button control unit 331 issues an inquiry to the favorite button processing unit 341 of the document storage unit 340, a generable button is a button for accessing a specific folder in the file storage area provided to the image forming apparatus 101, and, therefore, the favorite button processing unit 341 returns “Box”, which is a character string indicating that. Then, in step S1405, the favorite button control unit 331 adds this character string to a function list that should be reported to the information processing apparatus 100. Subsequently, in step S1406, the favorite button control unit 331 determines whether the selected function is the last function. If the favorite button control unit 331 determines in step S1406 that the selected function is the last function (YES in step S1406), then in step S1408, the favorite button control unit 331 returns the generated function list to the favorite button operation unit 312 of the information processing apparatus 100. Then, the present processing ends. On the other hand, if the favorite button control unit 331 determines in step S1406 that the selected function is not the last function (NO in step S1406), then in step S1407, the favorite button control unit 331 selects the next function. Then, the processing proceeds to step S1404 again, and the favorite button control unit 331 repeats the inquiry about a function and the addition to the function list until the favorite button control unit 331 reaches the last function.

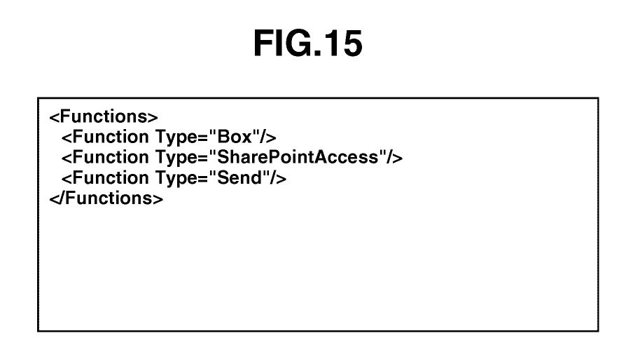

FIG. 15 illustrates an example of a data format of the function list acquired in response to a request for acquisition of functions for which a favorite button can be generated from the information processing apparatus 100 illustrated in FIG. 2. FIG. 15 illustrates that the image forming apparatus 101 has three functions for which a favorite button can be generated, and a favorite button can be generated for the functions “Box”, “SharePointAccess”, and “Send”.

Now, the subsequent steps in the flowchart illustrated in FIG. 13 will be described. In step S1302, after acquiring the list (refer to FIG. 15) of functions for which a favorite button can be generated from the image forming apparatus 101, the favorite button operation unit 312 determines whether a favorite button can be generated for the function of accessing the registration target library with use of that information. For example, when the registration target library is a box library, a favorite button can be generated for it if the acquired function list contains “Box”. Alternatively, when the registration target library is a SharePointServer library, the favorite button operation unit 312 determines that a favorite button can be generated for it if the acquired function list contains “SharePointAccess”. On the other hand, if the function of accessing the registration target library is not contained in the function list (NO in step S1302), the favorite button operation unit 312 does not register a favorite button.

If the favorite button operation unit 312 determines in step S1302 that a favorite button can be generated for the function of accessing the registration target library (YES in step S1302), the processing proceeds to step S1303. Then, in step S1303, the information processing apparatus 100 applies authentication to the image forming apparatus 101 as a preliminary preparation for generation of a favorite button. In this authentication processing, the printer authentication unit 313 of the information processing apparatus 100 requests authentication to the authentication management unit 320 of the image forming apparatus 101. If the favorite button operation unit 312 determines in step S1304 that there is no authentication function (NO in step S1304), then in step S1305, the favorite button operation unit 312 acquires the information about an already registered shared button from the image forming apparatus 101. Upon receiving a request for acquisition of the shared button information from the information processing apparatus 100, the favorite button control unit 331 of the image forming apparatus 101 returns the information about a registered shared button to the favorite button operation unit 312 of the information processing apparatus 100.

Then, in step S1306, upon acquisition of the shared button information from the image forming apparatus 101, the favorite button operation unit 312 confirms whether there is already a button for accessing the same path as the path of the registration target library. If the favorite button operation unit 312 determines in step S1306 that there is already a button for accessing the same path in the shared button information (YES in step S1306), the present processing ends without newly generating a favorite button since there is no need to have two buttons for accessing the same location.

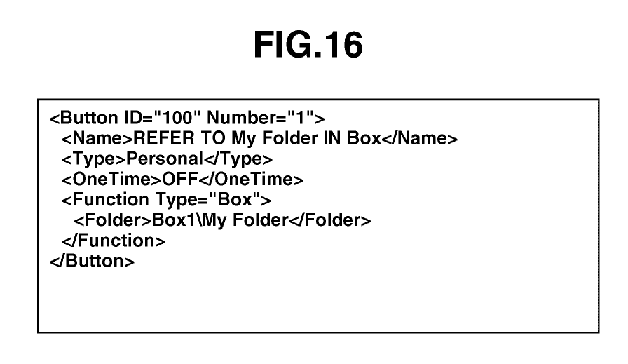

On the other hands, if the favorite button operation unit 312 determines in step S1306 that there is no information about a button for accessing the same path in the shared button information (NO in step S1306), then in step S1307, the favorite button operation unit 312 generates information for generating a favorite button to be registered. The generated content varies depending on the library type. For example, for a SharePointServer library, the favorite button operation unit 312 generates the information as illustrated in FIG. 9. For a box library, the favorite button operation unit 312 generates the information as illustrated in FIG. 16. Since the required information varies depending on the function, the content of the setting file should be changed for each function. The content of the “Function” tag illustrated in FIG. 9 defines the function information. If the function type is “SharePointAccess”, a Uniform Resource Locator (URL) should be set in the “Path” tag. Further, if the function type is “Box”, the path from the root of the file storage area provided to the image forming apparatus 101 should be set in the “Folder” tag.

In step S1308, after generating the information about the favorite button to be registered, the favorite button operation unit 312 transmits a button generation request of a shared button to request button generation according to the settings defined in the generated information to the favorite button control unit 331 of the image forming apparatus 101. Upon receiving the shared button generation request, the favorite button control unit 331 of the image forming apparatus 101 generates button data based on the received data, and generates a button by transferring the generated data to the favorite button generation unit 332.

On the other hand, if the favorite button operation unit 312 determines in step S1309 that the authentication has failed in the authentication processing to the image forming apparatus 101 (YES in step S1309), the present processing ends without generating a favorite button. On the other hand, if the favorite button operation unit 312 determines in step S1309 that the authentication has been successfully completed (NO in step S1309), subsequently, in step S1310, the favorite button operation unit 312 determines whether the registration information file illustrated in FIG. 6 is used as the library registration method. If the favorite button operation unit 312 determines in step S1310 that the registration information file illustrated in FIG. 6 is used as the library registration method (YES in step S1310), the processing proceeds to step S1305. Then, the favorite button operation unit 1312 generates a favorite button as a shared button.

On the other hand, if the favorite button operation unit 312 determines in step S1310 that the user registers the library by inputting information on the UI screen illustrated in FIG. 6 without using the registration information file (NO in step S1310), the processing proceeds to step S1311. Insteps S1311 and S1312, the favorite button operation unit 312 generates a favorite button as a “My Button” of the user who is logging in. These steps are similar to steps S1307 and S1308, and, therefore, the description thereof will be omitted here.

After the information processing apparatus 100 generates a favorite button in step S1311, then in step S1313, the information processing apparatus 100 stores the ID of the generated favorite button and the IP address of the image forming apparatus 101 at which the favorite button is generated, as button generation information. Then, the present processing ends. The library operation unit 308 stores the library information in the library registration information storage unit 309 during the library registration processing, with which the storage of the button generation information is realized.

Execution of the processing illustrated in FIG. 13 enables automatic generation of a favorite button for accessing the same location as a library at the image forming apparatus 101 during the library registration processing. In this way, according to the present exemplary embodiment, during library registration, a button for accessing the registered library is generated at the image forming apparatus 101. Then, a user has only to select (push) this button (shortcut) on the image forming apparatus 101 to directly access the target library to refer to the information of the library from the image forming apparatus 101.

Further, according to the present exemplary embodiment, in step S1304, it is possible to confirm whether the image forming apparatus 101 has the user authentication function, and generate a different favorite button according to the library registration method. More specifically, the favorite button operation unit 312 instructs the image forming apparatus 101 to generate either a favorite my button or a favorite shared button as a favorite button for accessing the registered library. As a result, it is possible to generate a favorite my button or a favorite shared button as a button for accessing the registered library at the image forming apparatus 101.

In the present exemplary embodiment, SharePointServer is used as a file storage area on the Internet, but this is merely an example. A storage area such as a WebDAV server or GoogleDocs may be used as a file storage area on the Internet.

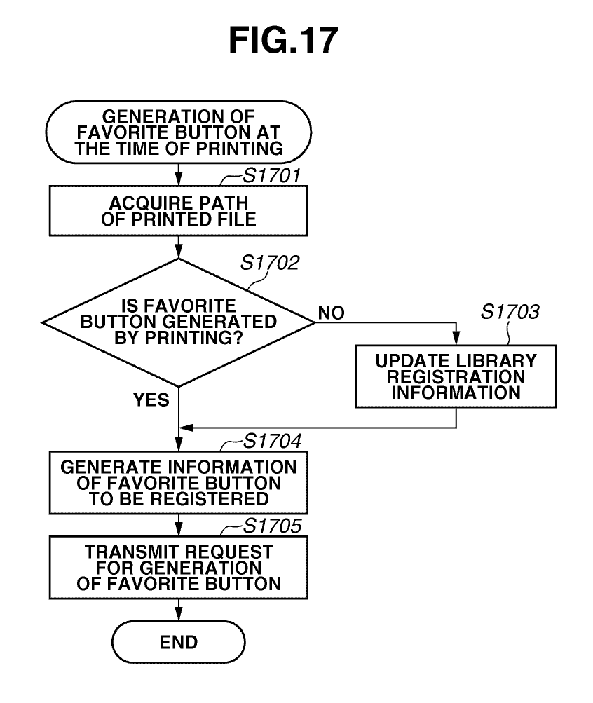

FIG. 17 is a flowchart illustrating a data processing method by the information processing apparatus 100 according to the present exemplary embodiment. This processing is an example of processing for generating a favorite button when a file is printed. The CPU 200 of the information processing apparatus 100 illustrated in FIG. 2 loads the control program and the above-described modules onto the RAM 201 to execute them, by which the respective steps in this example are realized. Hereinafter, the document processing method will be described as if the modules illustrated in FIG. 3 perform control actually.

When a file is printed by the image forming apparatus 101, the document operation unit 305 of the information processing apparatus 100 transmits a request for favorite button generation to the library operation unit 308, together with the path of the folder where the printed file exists. First, in step S1701, the favorite button operation unit 312 receives the path of the printed file from the library operation unit 308. Then, in step S1702, the favorite button operation 312 determines whether a favorite button is generated in the library registration information by the print operation. As indicated in the data illustrated in FIG. 8, the library information contains the “Button” tag retaining the information about a generated button.

In this data, “LastPrint” set in the “Type” attribute indicates that the corresponding button ID is a button ID of a favorite button generated based on the information of a file printed last. If the favorite button operation unit 312 determines that there is a button ID having “LastPrint” set in the “Type” attribute (YES in step S1702), then in step S1704, the favorite button operation unit 312 generates information of a button to be registered with use of that ID. Subsequently, in step S1705, the favorite button operation unit 312 transmits a request for generation of a favorite button to the image forming apparatus 101 based on that information. Then, the present processing ends.

On the other hand, if the favorite button operation unit 312 determines in step S1702 that there is no button ID having “LastPrint” set in the “Type” attribute (NO in step S1702), the processing proceeds to step S1703. In step S1703, the favorite button operation unit 312 newly generates a button ID, sets “LastPrint” in the “Type” attribute of that ID, and adds it to the library registration information. Then, in step S1704, the favorite button operation unit 312 generates information of a favorite button for accessing the folder where the printed file exists with use of the new button ID, and then the processing proceeds to step S1705. In step S1705, the favorite button operation unit 312 transmits a request for generation of a favorite button to the image forming apparatus 101 based on that information. Then, the present processing ends. Using the same button ID to generate a favorite button results in overwriting of an existing button having the same button ID.

When a new button ID is different from any other existing button IDs, the favorite button operation unit 312 additionally generates a new button. At this time, the favorite button operation unit 312 may generate a favorite button only at the image forming apparatus that has printed the file, or at all image forming apparatuses managed by the printer management unit 310. In this case, the favorite button operation unit 312 determines registration processing with use of the “Target” attribute of the “Button” tag of the library registration information. The favorite button generation processing has been already described, and, therefore, is not repeatedly described here. The present exemplary embodiment has been described as processing of generating a favorite button when an operation is applied to a document. Similar processing can be applied to not only a print operation but also to, for example, an operation of editing and storing a document and an operation of opening a document.

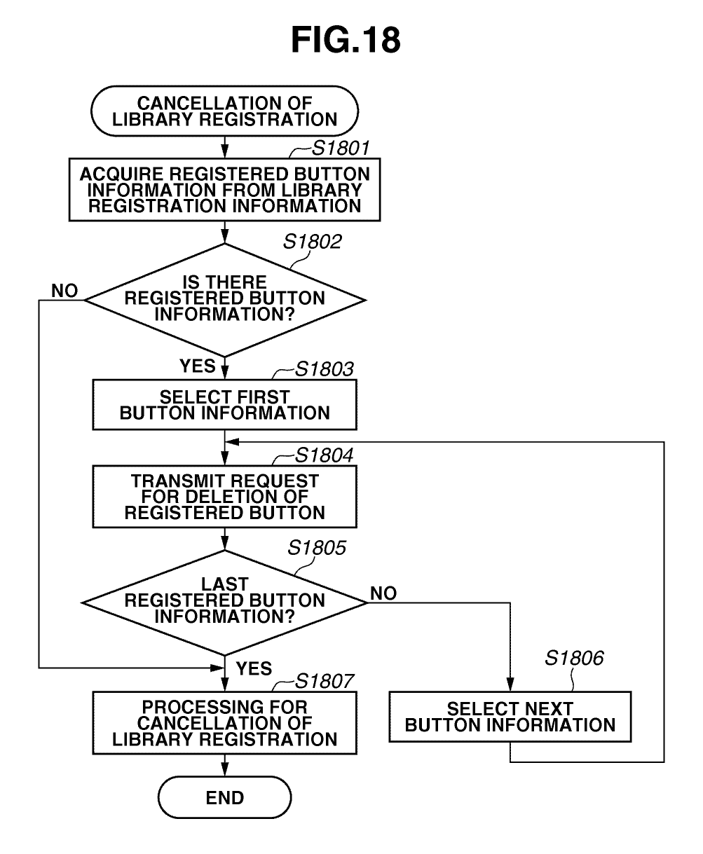

FIG. 18 is a flowchart illustrating a data processing method by the information processing apparatus 100 according to the present exemplary embodiment. The present example is an example of processing for cancelling registration of a library. The CPU 200 of the information processing apparatus 100 illustrated in FIG. 2 loads the control program and the above-described modules onto the RAM 201 to execute them, by which the respective steps in this example are realized. Hereinafter, the document processing method will be described as if the modules illustrated in FIG. 3 perform control actually.

First, in step S1801, upon receiving a request for cancellation of library registration, the library operation unit 308 of the information processing apparatus 100 refers to the library registration information of the library for which the registration is to be cancelled from the library registration information storage unit 309, and acquires the information of the registered buttons. Subsequently, in step S1802, the library operation unit 308 determines whether there is any registered button information. If the library operation unit 308 determines in step S1802 that there is no registered button information (NO in step S1802), then in step S1807, the library operation unit 308 deletes the library registration information of that library from the library registration information storage unit 309, thereby cancelling the library registration. Then, the present processing ends. On the other hand, if the library operation unit 308 determines in step S1802 that there is registered button information (YES in step S1802), then in step S1803, the library operation unit 308 selects the first button information to perform processing.

Subsequently, in step S1804, the library operation unit 308 transmits a request for deletion of the favorite button (cancellation instruction) with the button ID information to be deleted added thereto to the image forming apparatus 101, addressing the IP address of the registered image forming apparatus 101 stored in the button information. At this time, upon receiving the deletion request, the favorite button control unit 331 of the image forming apparatus 101 deletes the button having the corresponding button ID. If there is no button having the corresponding button ID, the image forming apparatus 101 ends the processing without deleting anything.

Subsequently, in step S1805, the library operation unit 308 of the information processing apparatus 100 determines whether the deleted button information is the last button information. If the library operation unit 308 determines that the deleted button information is the last button information (YES in step S1805), the processing proceeds to step S1807. In step S1807, the library operation unit 308 cancels the library registration. Then, the present processing ends. On the other hand, if the library operation unit 308 determines in step S1805 that the deleted button information is not the last button information (NO in step S1805), then in step S1806, the library operation unit 308 selects the next button information. Then, the processing proceeds to step S1804 again, in which the library operation unit 308 deletes a button, repeating the present processing until the library operation unit 308 reaches the last button information. The setting information indicated in the description of the present exemplary embodiment is expressed in an Extensible Markup Language (XML) format by way of example, but the setting information may be expressed in any format interpretable as the setting information.

In a second exemplary embodiment of the present invention, when a library is registered, a favorite button reference folder is generated in the external memory 209 of the information processing apparatus 100, and the path of the folder is registered with the image forming apparatus 101 as a favorite button. In the present exemplary embodiment, the location referred to by a favorite button can be set by, for example, generating a folder “For Print” in a root of a registered library to use it as the favorite button reference folder. Alternatively, a root of a library itself can be used as the favorite button reference folder.

Only differences of the present exemplary embodiment from the first exemplary embodiment are that a favorite button reference folder (favorite folder) is generated by folder generation processing during the library registration processing illustrated in FIG. 12, and the information of a favorite button to be registered is generated with use of the path of the favorite button reference folder as the information in steps S1306 and S1310 illustrated in FIG. 13. The details of the processing except for these differences are similar to the processing illustrated in above-described FIGS. 12 and 13.

In the button generation processing for generating the favorite button at this time, the “One Time” attribute, which indicates deletion of the favorite button after use thereof once, is set to ON in the information of the generated favorite button. As a result, it is possible to even delete a print document when the favorite button is pushed on the image forming apparatus 101. According to the second exemplary embodiment, when the information processing apparatus 100 generates a printed document or binder document, a document in a format printable by the image forming apparatus 101 is generated in the favorite button reference folder.

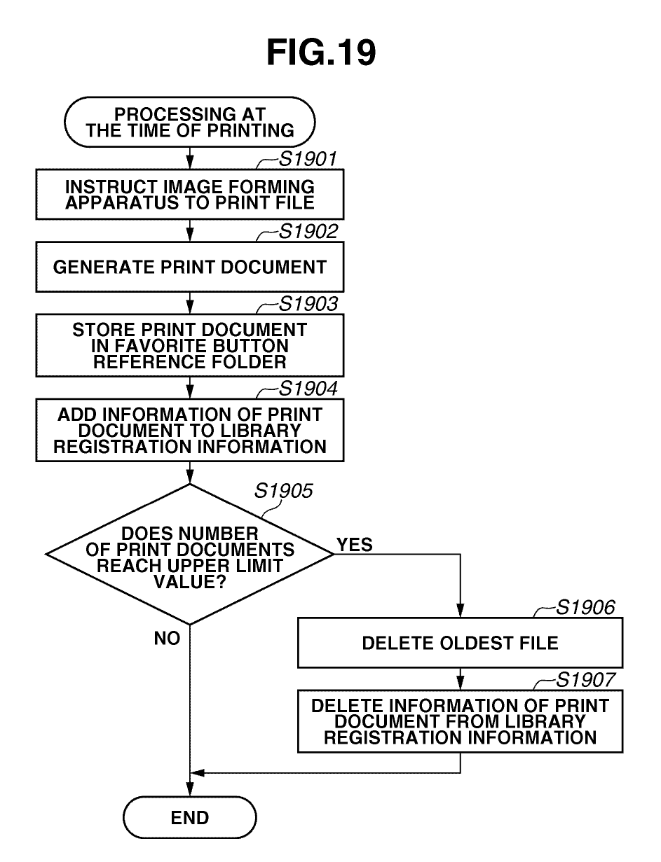

FIG. 19 is a flowchart illustrating a data processing method by the information processing apparatus 100 according to the present exemplary embodiment. The present example is an example of data processing performed when a document is printed. The CPU 200 of the information processing apparatus 100 illustrated in FIG. 2 loads the control program and the above-described modules onto the RAM 201 to execute them, by which the respective steps in this example are realized. Hereinafter, the document processing method will be described as if the modules illustrated in FIG. 3 perform control actually.

First, a user selects a document displayed on the display apparatus 208 by operating the input device, and then the document operation unit 305 of the information processing apparatus 100 selects an image forming apparatus to be used for a print operation among icons displayed on the printer display unit 303. Then, in step S1901, the document operation unit 305 transmits the information of the selected document to the printer management unit 310. The printer management unit 310 issues a print request to the printer print instruction unit 311. Upon receiving the print request, the printer print instruction unit 311 issues a print instruction to the printing unit 370 of the selected image forming apparatus via the printer driver, thereby printing the file.

Subsequently, in step S1902, the document operation unit 305 of the information processing apparatus 100 generates a print document for enabling the printed document to be printed by the image forming apparatus 101. The print document is stored in a format printable directly by the image forming apparatus 101. For example, if the image forming apparatus 101 has the function of interpreting and printing Portable Document Format (PDF) data, the print document is stored as PDF data. If the image forming apparatus 101 has the function of interpreting and printing data in an image format such as Joint Photographic Experts Group (JPEG), the print document is stored as JPEG data. Alternatively, the print data may be stored in any other format allowing the image forming apparatus 101 to directly print it, instead of the PDF or JPEG format. Further, the print document can be generated in a state suitable to print settings at the time of printing.

Then, in step S1903, the document operation unit 305 stores the generated print document in the favorite button reference folder generated when the library is registered. After storing the print document in the favorite button reference folder, in step S1904, the document operation unit 305 adds this information to the library registration information of the library where the printed document exits.

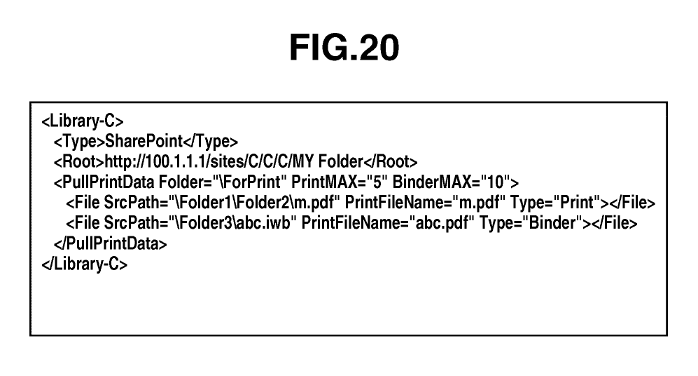

FIG. 20 illustrates an example of the data format of the library registration information storing the library information in the information processing apparatus 100 illustrated in FIG. 2. In this example, according to the generation of the favorite button reference folder, a reference button for referring to the favorite button reference folder is automatically generated at the image forming apparatus 101. The library operation unit 308 generates the favorite button reference folder by exerting the reference folder generation function.

Referring to FIG. 20, the library registration information stores the folder path of the favorite button reference folder, the path of the document stored in the favorite button reference folder, the reason for the generation, and the upper limit of storable print documents for each reason for the generation. The favorite button reference folder corresponds to “PullPrintDataFolder”.

In the example illustrated in FIG. 20, the information of the favorite button reference folder is described within the “PullPrintData” tag. The path of the favorite button reference folder is set in the “Folder” attribute. Then, the upper limit of print documents, generation of which is triggered by a print operation, is set in the “PrintMAX” attribute, and the upper limit of print documents generated for a binder document is set in the “BinderMAX” attribute. When a document is printed, the “File” tag is added to the bottom within the “PullPrintData” tag, and the file path where the printed document exits is set in the “SrcPath” attribute. Further, the filename of the print document stored in the favorite button reference folder is set in the “PrintFileName” attribute. Then, the information “Print” is set in the “Type” attribute to indicate that the generation of the print document is triggered by a print operation. For a binder document, the information “Binder” is set in the “Type” attribute.

Further, during the addition of the library registration information, the document operation unit 305 refers to all information of print documents in the library registration information, and if there is no document with the name matching the “PrintFileName” attribute in the favorite button reference folder, deletes the information of the “File” tag of this file. As a result, it is possible to prevent unnecessary information from remaining, when a user deletes a print document or when the image forming apparatus 101 deletes a document when the favorite button is executed.

Subsequently, in step S1905, the document operation unit 305 of the information processing apparatus 100 checks how many print documents the favorite button reference folder contains as print documents, generation of which is triggered by a print operation, and determines whether the number of stored print documents reaches a preset upper limit number. The upper limit number is set to prevent such a situation that print documents are limitlessly generated in the favorite button reference folder.

In the example illustrated in FIG. 20, “5” is set as the upper limit number for print documents, generation of which is triggered by a print operation. Therefore, the document operation unit 305 checks whether there are “6 (which is the value larger than “MAX”)” or more documents with “Print” set to the “Type” attribute in the “File” tag within the “PullPrintData” tag. If there is 6 or more documents satisfying this condition (YES in step S1905), the document operation unit 305 reads the information described in the “File” tag stored at the top among the “File” tags with “Print” set to the “Type” attribute. Then, in step S1906, the document operation unit 305 deletes the document corresponding to the filename described in “PrintFileName” from the favorite button reference folder. After the document operation unit 305 deletes the file in this way, in step S1907, the library operation unit 308 deletes the “File” tag of the deleted document from the library registration information. The upper limit number may be any number.

In the present exemplary embodiment, the upper limit number is set for the number of print documents to determine deletion of a print document. An alternative method is to store the generated time, and delete a file after a predetermined time has passed. Further, another alternative method is to delete the document registered first when the total size of the favorite button reference folder reaches an upper limit number. Further, after printing a selected document on the image forming apparatus 101 from documents registered in the favorite button reference folder as a reference folder, the image forming apparatus 101 issues, to the information processing apparatus 100, a print completion notification indicating that the selected document has been printed. Upon receiving this notification, the library management unit 304 of the information processing apparatus 100 deletes the document for which the print completion notification has been received, from the favorite button reference folder. As a result, it is possible to automatically prevent occurrence of such a state that a document printed once remains in the favorite button reference folder and is kept managed without being deleted.

The information processing apparatus 100 also generates a print document when a binder document is generated, in a similar manner to the above-described processing at the time of printing illustrated in FIG. 19. In this case, the information processing apparatus 100 should monitor the state of the original binder document based on which the print document is generated, and update the print document and the library registration information according to an operation. For example, when the document operation unit 305 deletes a binder document, the document operation unit 305 compares the path of the deleted binder document with the “SrcPath” attribute of the print document information in the library registration information. If the document operation unit 305 determines that there is a document that matches the deleted binder document, the document operation unit 305 deletes the document corresponding to the “PrintFileName” attribute in the “File” tag having the matching SrcPath, from the favorite button reference folder, and deletes the information of the “File” tag. When the binder document is updated, the print document is also updated. Further, this processing can be applied to not only a binder document but also a document in a commonly-used file format.

According to the present exemplary embodiment, it is possible to automatically provide the image forming apparatus 101 with a button allowing a user to directly access a library from the image forming apparatus 101 when the user registers the library. Further, it is possible to automatically provide the image forming apparatus 101 with a button allowing a user to directly access a favorite folder generated in a library from the image forming apparatus 101, when the user registers the library.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment (s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-170022 filed Aug. 3, 2011, which is hereby incorporated by reference herein in its entirety.

What is claimed is:

1. An information processing system comprising:
an image forming apparatus; and
an information processing apparatus,
the information processing apparatus comprising:
a registration unit configured to register a library; and
an instruction unit configured to instruct the image forming apparatus to generate a button for accessing the registered library when the registration unit registers the library,
the image forming apparatus comprising:
a generation unit configured to generate the button for accessing the library from the image forming apparatus according to an instruction from the instruction unit; and
a control unit configured to display the button generated by the generation unit on a display unit, and to access the library in response to selection of the displayed button.

2. The information processing system according to claim 1, wherein the information processing apparatus further comprises a confirmation unit configured to confirm whether the image forming apparatus includes a function of authenticating a user, and
wherein, in a case where the confirmation unit confirms that the image forming apparatus includes the function of authenticating a user, the information processing apparatus instructs the image forming apparatus to generate one of a user-specific button and a shared button as the button for accessing the library according to a method for registering the library.

3. The information processing system according to claim 2, wherein the generation unit generates one of the user-specific button and the shared button as the button for accessing the library from the image forming apparatus according to the instruction from the instruction unit.

4. The information processing system according to claim 1, wherein the instruction unit instructs the image forming apparatus to delete the generated button for accessing the library when the instruction unit instructs deletion of the registered library.

5. The information processing system according to claim 1, wherein the control unit deletes the button for accessing the library according to an instruction to delete the library, which is received from the information processing apparatus.

6. The information processing system according to claim 1, wherein the library is prepared in a storage area managed by one of the information processing apparatus, the image forming apparatus, and a storage service on a network.

7. The information processing system according to claim 1, wherein the information processing apparatus further comprises a reference folder generation unit configured to generate a reference folder when a document is stored in the library registered by the registration unit, the reference folder being referred to by the image forming apparatus for printing the document, and
wherein the instruction unit instructs the image forming apparatus to generate a reference button for accessing the reference folder from the image forming apparatus according to the reference folder generation unit generating the reference folder.

8. The information processing system according to claim 7, wherein, when the number of documents stored in the reference folder exceeds a preset upper limit number, the registration unit deletes a document having an oldest registration date among the documents.

9. The information processing system according to claim 7, wherein, when the information processing apparatus receives, from the image forming apparatus, a print completion notification indicating that a document selected from the reference folder has been completely printed, the registration unit deletes the document associated with the print completion notification from the reference folder.

10. An information processing system comprising:
an image forming apparatus; and
an information processing apparatus,
the information processing apparatus comprising:
a registration unit configured to register a library;
a folder generation unit configured to generate a folder to be referred to by the image forming apparatus when the registration unit registers the library; and
an instruction unit configured to instruct the image forming apparatus to generate a button for accessing the folder generated by the folder generation unit,
the image forming apparatus comprising:
a button generation unit configured to generate the button for accessing the folder generated in the library from the image forming apparatus according to an instruction from the instruction unit; and
a control unit configured to display the button generated by the button generation unit on a display unit, and to access the folder generated in the library in response to a user selecting the displayed button.

11. A button processing method comprising:
registering a library;
generating a button for accessing the registered library when the library is registered;
generating the button for accessing the library;
displaying the generated button; and
accessing the library in response to selection of the displayed button.

12. A button processing method comprising:
registering a library;
generating a folder to be referred to when the library is registered;
generating a button for accessing the generated folder;
generating the button for accessing the folder generated in the library;
displaying the generated button; and
accessing the folder generated in the library in response to selection of the displayed button.

13. An information processing apparatus that communicates with an image forming apparatus, the information processing apparatus comprising:
a registration unit configured to register a library; and
an instruction unit configured to instruct the image forming apparatus to generate a button for accessing the registered library when the registration unit registers the library,
wherein the image forming apparatus generates the button for accessing the library from the image forming apparatus according to an instruction from the instruction unit.

14. A computer-readable storage medium storing a computer-executable process for controlling a computer that communicates with an image forming apparatus, the computer-executable process comprising:
registering a library; and
instructing the image forming apparatus to generate a button for accessing the registered library when the library is registered,
wherein the image forming apparatus generates the button for accessing the library from the image forming apparatus according to an instruction from the computer.
